(19) United States
(12) Patent Application Publication
(10) Pub. No.: US 2007/0050173 A1
(43) Pub. Date: Mar. 1, 2007

(54) Computer-controlled fan unit reliability testing system

(75) Inventors: Wei-I Chen, Tapei (TW); Chin-Lung Lien, Taipei (TW); Jui-Cheng Hun, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/218,381

(22) Filed: Sep. 1, 2005

(51) Int. Cl. G21C 17/00

(52) U.S. Cl. 702/182

(57) ABSTRACT

A computer-controlled fan unit reliability testing system is proposed, which is designed for the purpose of performing a computer-controlled fully-automatic reliability testing procedure on a batch of fan units, and which is characterized by the use of computer automation to perform a fully-automatic reliability testing procedure on the fan units under testing at the same time, and the capability of concurrently measuring a set of operational characteristics, including ampere consumption of each individual fan unit and the total ampere consumption of all of the batch of fan units, fan fault (FF) signal of each individual fan unit, and revolution signal of each individual fan unit, which can be finally automatically compiled into an electronic-file testing result report. This feature allows the testing procedure to be fully-automatic and more convenient and time-saving, and is therefore much more efficient than prior art.

### BACKGROUND OF THE INVENTION

1. Field of the Invention

This invention relates to automatic testing technology, and more particularly, to a computer-controlled fan unit reliability testing system which is designed for the purpose of performing a computer-controlled fully-automatic reliability testing procedure on a batch of fan units, such as fan-based heat dissipating units used on electronic systems.

2. Description of Related Art

Electronic systems typically produce large amounts of heat during operation due to consumption of electrical power, and if this heat is undissipated, it would result in the burnout of electrical components or chips, thus causing the electronic system to shut down or fail to operate normally. One solution to this problem is to mount heat-dissipating devices, such as electrical fan units or coolant-driven air conditioners, for dissipating heat in the electronic system during operation. For example, most computer units such as network servers and desktop computers are typically equipped with one or more fan-based heat-dissipating units for use to generate air streams to blow away the heat generated by the network servers and desktop computers during operation.

In manufacture, when the assembly work for fan units is completed, it is a standard practice to perform a reliability testing procedure on the assembled fan units so as to check whether they would operate normally as expected. Presently, a widely utilized testing method is to place a batch of fan units on the inside of an oven and electrically connect all of these fan units in parallel to a common power source so that these fan units can be driven to operate at the same time. This setup can test whether these fan units would operate normally under high-temperature conditions. After this, another testing procedure is performed by relocating all the fan units from the oven to another test platform where a RPM (revolutions per minute) stroboscope is utilized to measure the output speed of each of the fan units. After the RPM testing procedure is completed, all of the fan units are moved back to the oven to undergo the high-temperature testing procedure again.

One drawback to the foregoing reliability testing method, however, is that it requires human labor to manually move the batch of fan units between the oven and the RPM testing platform, and therefore is quite laborious and time-consuming. In addition, the foregoing reliability testing method is incapable of measuring the following operational characteristics: ampere consumption of each individual fan unit and the total ampere consumption of all of the batch of fan units, fan fault (FF) signal of each individual fan unit, and revolution signal of each individual fan unit. Moreover, since the working voltage of each fan unit would vary with speed during the testing procedure, it would be difficult to fix the working voltage at a standardized level, making the manufacturer unable to establish a standard testing operational procedure for IQC (Integrated Quality Control). Besides, since all of the data of operational characteristics are recorded by the test engineers who also manually compile these data into a test report, the involved work is quite laborious and time-consuming, and therefore quite inefficient.

### SUMMARY OF THE INVENTION

It is therefore an objective of this invention to provide a computer-controlled fan unit reliability testing system which allows a reliability testing procedure on a batch of fan units to be completed all on one single testing platform, without having to move between different testing platforms as in the case of prior art, so as to make the testing procedure more convenient and efficient.

It is another objective of this invention to provide a computer-controlled fan unit reliability testing system which is capable of measuring a set of operational characteristics, including ampere consumption of each individual fan unit and the total ampere consumption of all of the batch of fan units, fan fault (FF) signal of each individual fan unit, and revolution signal of each individual fan unit.

It is still another objective of this invention to provide a computer-controlled fan unit reliability testing system which is capable of automatically generating an electronic-file testing result report through computer automation based on the measured data of operational characteristics of a batch of fan units under testing.

The computer-controlled fan unit reliability testing system according to the invention is designed for the purpose of performing a computer-controlled fully-automatic reliability testing procedure on a batch of fan units, such as fan-based heat dissipating units used on electronic systems.

In architecture, the computer-controlled fan unit reliability testing system comprises: (a) a batch-type fan unit fixture module, which is capable of connecting the computer-controlled fan unit reliability testing system to the batch of fan units under testing; (b) a monitoring control module, which is capable of providing a control interface for user-control of the testing procedure on the fan units; (c) a programmable power supply module, which is capable of generating a user-specified level of electrical power under control of the monitoring control module and supplying the electrical power by way of the batch-type fan unit fixture module to each of the fan units under testing for the purpose of driving the fan units to start operation; (d) a speed control signal generating module, which is capable of generating a user-specified level of speed control signal under control by the monitoring control module and transferring the speed control signal by way of the batch-type fan unit fixture module to each of the fan units under testing for the purpose of driving the fan units to operate at a specified speed; and (e) an operational characteristics detecting module, which is capable of being activated when the fan units are powered by the programmable power supply module and speed-controlled by the speed control signals from the speed control signal generating module, for detecting a set of feedback operational characteristic response signals from each of the fan units under testing and transferring the detected operational characteristics to the monitoring control module for processing into user-readable form.

The computer-controlled fan unit reliability testing system according to the invention is characterized by the use of computer automation to perform a fully-automatic reliability testing procedure on the fan units under testing at the same time, and the capability of concurrently measuring a set of operational characteristics, including ampere consumption of each individual fan unit and the total ampere consumption of all of the batch of fan units, fan fault (FF) signal of each individual fan unit, and revolution signal of each individual fan unit, which can be finally automatically compiled into an electronic-file testing result report for reviewing and evaluation by test engineers. The feature allows the testing procedure to be fully-automatic and more convenient and time-saving to perform, and is therefore much more efficient than prior art.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application and system architecture of the computer-controlled fan unit reliability testing system according to the invention; and

FIG. 2 is a schematic diagram showing the internal architecture of an operational characteristics detecting module utilized by the computer-controlled fan unit reliability testing system of the invention.

### DETAILED DESCRIPTION OF PREFERRED EMBODIMENTS

The computer-controlled fan unit reliability testing system according to the invention is disclosed in full details by way of preferred embodiments in the following with reference to the accompanying drawings.

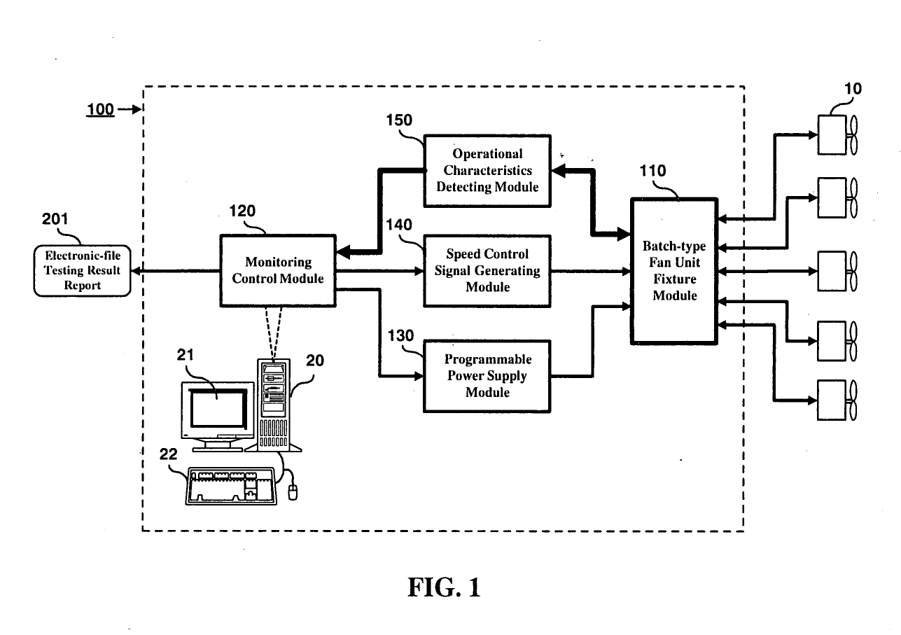

FIG. 1 is a schematic diagram showing the application and system architecture of the computer-controlled fan unit reliability testing system according to the invention (as the part enclosed in the dotted box indicated by the reference numeral 100). As shown, the computer-controlled fan unit reliability testing system of the invention 100 is designed for use to perform a computer-controlled fully-automatic reliability testing procedure on a batch of fan units 10, such as fan-based heat dissipating units that are to be used on electronic systems for heat-dissipating purpose.

As shown in FIG. 1, the system architecture of the computer-controlled fan unit reliability testing system of the invention 100 comprises: (a) a batch-type fan unit fixture module 110; (b) a monitoring control module 120; (c) a programmable power supply module 130; (d) a speed control signal generating module 140; and (e) an operational characteristics detecting module 150.

The batch-type fan unit fixture module 110 is a fixture that is designed to connect the computer-controlled fan unit reliability testing system of the invention 100 to a batch of fan units 10 under testing, so as to allow the computer-controlled fan unit reliability testing system of the invention 100 to be capable of simultaneously supplying power and speed control signals to these fan units 10 and fetching operational characteristic response signals from these fan units 10 during testing operation. In practical implementation, for example, the batch-type fan unit fixture module 110 is designed to hold at least 64 fan units (in the embodiment of FIG. 1, only 5 fan units are shown for demonstrative purpose; however, the number of fan units that can be connected to the batch-type fan unit fixture module 110 is unrestricted).

The monitoring control module 120 is realized, for example, by a computer program installed on a computer platform 20, such as a personal computer, which is linked via a special interface to the programmable power supply module 130, the speed control signal generating module 140, and the operational characteristics detecting module 150, for providing a user-operated testing procedure control function for test engineers. With the monitoring control module 120, the user is able to utilize the input device (such as keyboard and mouse) 22 of the computer platform 20 to specify a set of testing parameters related to power and speed control signal for the programmable power supply module 130 to generate a specified level of electrical voltage and the speed control signal generating module 140 to generate a specified level of speed control signal. Moreover, the monitoring control module 120 is capable of receiving a set of feedback operational characteristic response signals from the operational characteristics detecting module 150 that are fetched by way of the batch-type fan unit fixture module 110 from the fan units 10 during actual testing operation. Moreover, the monitoring control module 120 is capable of processing the received data of operational characteristics into graphs or readable text and displaying these processed results on the screen 21 for viewing by the test engineers.

The programmable power supply module 130 is capable of generating a user-specified level of electrical power, such as DC (direct current) electrical power, under user control via the monitoring control module 120 on the computer platform 20, where the DC power can be user-specified within a predetermined range, such as 0 V-30 V/86A (note that the range of DC power is an arbitrary design choice and has no specific restrictions). The generated electrical power is transferred by way of the batch-type fan unit fixture module 110 to each of the fan units 10 under testing.

The speed control signal generating module 140 is capable of generating a speed control signal under user control via the monitoring control module 120 on the computer platform 20, and capable of transferring the speed control signal by way of the batch-type fan unit fixture module 110 to each of the fan units 10 under testing for the purpose of driving the fan units 10 to operate at a specified speed. In practical implementation, for example, the speed control signal can be a PWM (Pulse Width Modulation) signal which utilizes various pulse widths to control the speed of the fan units 10, or a linear voltage signal which utilizes various levels of voltages to control the speed of the fan units 10. Since the use of PWM or linear voltage for control of fan speed is well-known techniques in the electronics industry, detailed description thereof will not be given in this specification. In the case of PWM speed control method, the speed control signal generating module 140 allows the user to utilize the monitoring control module 120 to set the PWM speed control signal at a desired frequency in the range from 10 Hz to 200 kHz, a desired duty cycle in the range from 1% to 99%, and a desired amplitude in the range from 0 V to 5 V (volt). On the other hand, in the case of linear voltage speed control method, the speed control signal generating module 140 allows the user to utilize the monitoring control module 120 to set the speed control voltage in the range from 0 V to 15 V (volt). It is to be noted that the specific ranges of these user-adjustable parameters described here are merely an arbitrary design choice and not intended as restrictions to the invention.

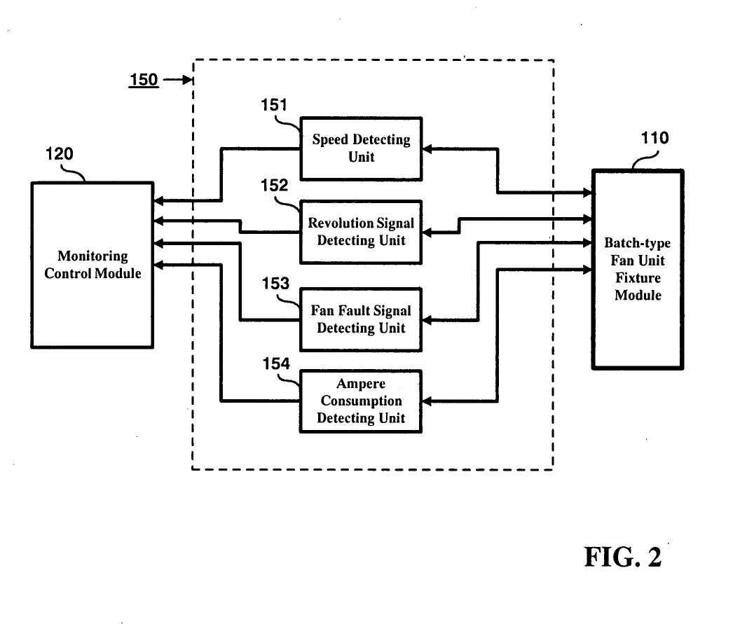

The operational characteristics detecting module 150 is capable of being activated when the fan units 10 are powered by the programmable power supply module 130 and speed-controlled by the speed control signals from the speed control signal generating module 140, for detecting a set of feedback operational characteristic response signals from each of the fan units 10, and then capable of transferring the feedback response signals to the monitoring control module 120. In practical implementation, as shown in FIG. 2, the internal architecture of the operational characteristics detecting module 150 includes the following functional units: (e1) a speed detecting unit 151; (e2) a revolution signal detecting unit 152; (e3) a fan fault signal detecting unit 153; and (e4) an ampere consumption detecting unit 154.

The speed detecting unit 151 is capable of being activate when all the fan units 10 are started to operate after receiving the electrical power from the programmable power supply module 130 and the speed control signals from the speed control signal generating module 140, for detecting the output speed of each of the fan units 10 and transferring the detected speed values to the monitoring control module 120.

The revolution signal detecting unit 152 is capable of being activate when all the fan units 10 are started to operate after receiving the electrical power from the programmable power supply module 130 and the speed control signals from the speed control signal generating module 140, for detecting the output revolution signal of each of the fan units 10 and transferring the detected revolution signal values to the monitoring control module 120. Since the method of detecting revolution signal is a well-known technique in the electronics industry, detailed description thereof will not be given in this specification.

The fan fault signal detecting unit 153 is capable of being activate when all the fan units 10 are started to operate after receiving the electrical power from the programmable power supply module 130 and the speed control signals from the speed control signal generating module 140, for detecting the output fan fault signal of each of the fan units 10 and transferring the detected fan fault signal values to the monitoring control module 120. Since the method of detecting fan fault signal is a well-known technique in the electronics industry, detailed description thereof will not be given in this specification.

The ampere consumption detecting unit 154 is capable of being activate when all the fan units 10 are started to operate after receiving the electrical power from the programmable power supply module 130 and the speed control signals from the speed control signal generating module 140, for detecting the average ampere consumption of each individual fan unit 10 as well as the total ampere consumption of all of the fan units 10 and transferring the detected ampere consumption values to the monitoring control module 120. Since the method of detecting ampere consumption is a well-known technique in the electronics industry, detailed description thereof will not be given in this specification.

Referring to FIG. 1 together with FIG. 2, in actual operation,, the user (i.e., test engineers) can attach a batch of fan units 10 (such as 64 fan units) to the batch-type fan unit fixture module 110 so as to fix the fan units 10 in position and electrical couple the computer-controlled fan unit reliability testing system of the invention 100 to these fan units 10. Next, the user can utilize the monitoring control module 120 to specify a set of control parameters for the driving power and speed control signals that are to be used in the testing procedure. These control parameters will be then transferred to the programmable power supply module 130 and the speed control signal generating module 140, causing the programmable power supply module 130 to generate a driving voltage of a specified level based on the user-specified parameter, and causing the speed control signal generating module 140 to generate a speed control signal based on the user-specified parameters. The driving voltage and the speed control signal are then transferred by way of the batch-type fan unit fixture module 110 to each of the fan units 10, whereby the fan units 10 are started to operate. After the fan units 10 start operation, the operational characteristics detecting module 150 is activated to detect a set of feedback operational characteristic response signals from each of the fan units 10 under testing and transferring the feedback response signals to the monitoring control module 120; wherein the speed detecting unit 151 is responsible for detecting the output speed of each of the fan units 10 and transferring the detected speed values to the monitoring control module 120; the revolution signal detecting unit 152 is responsible for detecting the output revolution signal of each of the fan units 10 and transferring the detected revolution signal values to the monitoring control module 120; the fan fault signal detecting unit 153 is responsible for detecting the output fan fault signal of each of the fan units 10 and transferring the detected fan fault signal values to the monitoring control module 120; and the ampere consumption detecting unit 154 is responsible for detecting the average ampere consumption of each individual fan unit 10 as well as the total ampere consumption of all the fan units 10, and then transferring the detected ampere consumption values to the monitoring control module 120.

In response to the detected data of operational characteristic response signals from the operational characteristics detecting module 150, the monitoring control module 120 then processes the received data of speed values from the speed detecting unit 151, the revolution signal values from the revolution signal detecting unit 152, the fan fault signal values from the fan fault signal detecting unit 153, and the average ampere consumption and total ampere consumption values from the ampere consumption detecting unit 154 into graphs or readable text, and displaying these processed results on the screen 21 of the for viewing by the test engineers to learn the results of testing. Furthermore, the monitoring control module 120 is also capable of automatically collecting the detected operational characteristics (i.e., output speed, revolution signal, fan fault signal, and ampere consumption) and compiling these data into an electronic-file testing result report 201 through program control. The automatically-generated electronic-file testing result report 201 can then be distributed, for example, via network to all related management personnel for reviewing and evaluation.

In conclusion, the invention provides a computer-controlled fan unit reliability testing system which is designed for the purpose of performing a computer-controlled fully-automatic reliability testing procedure on a batch of fan units, and which is characterized by the use of computer automation to perform a fully-automatic reliability testing procedure on the fan units under testing at the same time, and the capability of concurrently measuring a set of operational characteristics, including ampere consumption of each individual fan unit and the total ampere consumption of all of the batch of fan units, fan fault (FF) signal of each individual fan unit, and revolution signal of each individual fan unit, which can be finally automatically compiled into an electronic-file testing result report for reviewing and evaluation by test engineers. The feature allows the testing procedure to be fully-automatic and more convenient and time-saving to perform, and is therefore much more efficient than prior art. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A computer-controlled fan unit reliability testing system for performing a computer-controlled reliability testing procedure on a batch of fan units;
the computer-controlled fan unit reliability testing system comprising:
a batch-type fan unit fixture module, which is capable of connecting the computer-controlled fan unit reliability testing system to the batch of fan units under testing;
a monitoring control module, which is capable of providing a control interface for user-control of the testing procedure on the fan units;
a programmable power supply module, which is capable of generating a user-specified level of electrical power under control of the monitoring control module and supplying the electrical power by way of the batch-type fan unit fixture module to each of the fan units under testing for the purpose of driving the fan units to start operation;
a speed control signal generating module, which is capable of generating a user-specified level of speed control signal under control by the monitoring control module and transferring the speed control signal by way of the batch-type fan unit fixture module to each of the fan units under testing for the purpose of driving the fan units to operate at a specified speed; and
an operational characteristics detecting module, which is capable of being activated when the fan units are powered by the programmable power supply module and speed-controlled by the speed control signals from the speed control signal generating module, for detecting a set of feedback operational characteristic response signals from each of the fan units under testing and transferring the detected operational characteristics to the monitoring control module for processing into user-readable form.

2. The computer-controlled fan unit reliability testing system of claim 1, wherein the speed control signal generated by the speed control signal generating module is a PWM (Pulse Width Modulation) signal.

3. The computer-controlled fan unit reliability testing system of claim 1, wherein the speed control signal is a linear voltage signal.

4. The computer-controlled fan unit reliability testing system of claim 1, wherein the operational characteristics detecting module includes:
a speed detecting unit, which is capable of being activate when all the fan units are started to operate after receiving the electrical power from the programmable power supply module and the speed control signals from the speed control signal generating module, for detecting the output speed of each of the fan units and transferring the detected speed values to the monitoring control module.

5. The computer-controlled fan unit reliability testing system of claim 1, wherein the operational characteristics detecting module includes:
a revolution signal detecting unit, which is capable of being activate when all the fan units are started to operate after receiving the electrical power from the programmable power supply module and the speed control signals from the speed control signal generating module, for detecting the output revolution signal of each of the fan units and transferring the detected revolution signal values to the monitoring control module.

6. The computer-controlled fan unit reliability testing system of claim 1, wherein the operational characteristics detecting module includes:
a fan fault signal detecting unit, which is capable of being activate when all the fan units are started to operate after receiving the electrical power from the programmable power supply module and the speed control signals from the speed control signal generating module, for detecting the output fan fault signal of each of the fan units and transferring the detected fan fault signal values to the monitoring control module.

7. The computer-controlled fan unit reliability testing system of claim 1, wherein the operational characteristics detecting module includes:
an ampere consumption detecting unit, which is capable of being activate when all the fan units are started to operate after receiving the electrical power from the programmable power supply module and the speed control signals from the speed control signal generating module, for detecting the average ampere consumption of each individual fan unit as well as the total ampere consumption of all of the fan units and transferring the detected ampere consumption values to the monitoring control module.

8. The computer-controlled fan unit reliability testing system of claim 1, wherein the monitoring control module is further capable of collecting the detected operational characteristics and compiling these data into an electronic-file testing result report.
